(19) United States
(12) Patent Application Publication
(10) Pub. No.: US 2004/0102273 A1
(43) Pub. Date: May 27, 2004

(54) Hydraulic type plastic tensioner

(76) Inventors: Tsutomu Namie, Osaka (JP); Kozo Inoue, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/716,335

(22) Filed: Nov. 18, 2003

Related U.S. Application Data
(62) Division of application No. 10/103,902, filed on Mar. 22, 2002.

(30) Foreign Application Priority Data
Mar. 27, 2001 (JP) 90517/2001

(51) Int. Cl. F16H 7/08; F16H 7/22

(52) U.S. Cl. 474/110; 474/109

(57) ABSTRACT

The present invention relates to a hydraulic type plastic tensioner comprising a body of the tensioner, which is made of plastics, a hollow metallic cylinder fit into a circular hole formed in the body, a plunger and a check valve mechanism. A ball seat in the check valve mechanism is provided on a bottom portion of the circular hole, and a retainer in a retainer-integrated type cylinder is press-fit onto the check ball to hold the cylinder in the circular hole.

### BACKGROUND OF THE INVENTION

The present invention relates to a hydraulic type tensioner, which applies proper tension to a traveling chain, belt or the like, and more specifically relates to a hydraulic type plastic tensioner in which a tensioner body was made of plastics.

FIG. 8 shows an example of a conventional hydraulic type tensioner 61. In this hydraulic type tensioner 61, an iron-based plunger 65 is slidably inserted into a cylinder chamber 63 formed in a metallic body 62. The metallic body 62 is a metallic die-cast product of iron or aluminum alloy.

In the inside of this plunger 65 is formed a hollow portion 66, whose lower end portion is opened, and in this hollow portion 66 is accommodated a compression spring 67, which biases the plunger 65 upward to apply proper tension to a chain or belt or the like (not shown). Further, this hollow portion 66 and the cylinder chamber 63 of the body 62 form a pressure oil chamber 68. The bottom portion of the pressure oil chamber 68 includes a check valve mechanism 69, which allows the flowing of oil into the pressure oil chamber 68 but blocks the back-flow of the oil.

The check valve mechanism 69 comprises a ball seat 69a press-fit into a circular hole 63a formed in a lower portion of the pressure oil chamber 68, a check ball 69b provided on an upper portion of a through-hole 69a′ in the ball seat 69a, a coil spring 69c, which biases the check ball 69b to the through-hole 69a side, and a retainer 69d, which supports an end of the coil spring 69c. The check ball 69b functions as a check valve. In this connection the reference numerals 62a and 62b are an oil flow-in port and an oil passage, respectively.

In the hydraulic type tensioner 61 having the above-mentioned construction, the oil pressure chamber 68 is always filled with oil supplied from the outside through the oil flow-in port 62a, oil passage 62b and check valve mechanism 69. When a traveling chain or belt or the like is loosened, the plunger 65 always biased with the compression spring 67 is protruded and the check valve mechanism 69 is opened so that oil flows into the oil pressure chamber 68. Further, when the plunger 65 is pushed into the cylinder chamber 63 by impact force, which acts on the tensioner from the chain, belt or the like, the oil pressure in the pressure oil chamber 68 is increased to close the check valve mechanism 69.

Thus, when the check valve mechanism 69 is closed, oil in the pressure chamber 68 is moved upward from a lower end of the plunger 65 through a small gap between an outer circumferential surface of the plunger 65 and an inner circumferential surface of the cylinder chamber 63 and discharged outside. At that time, the impact energy is absorbed by fluid resistance on the passing of oil through said gap so that cushion effect can be obtained.

Since a conventional hydraulic type tensioner is a die-cast product whose body is made of metal, there is a problem that the mass of the product is large, and the surface accuracy and durability of the cylinder chamber is poor. Thus, for the purpose of prevention of the occurrence of wear and burning of the plunger, to obtain improved surface accuracy and durability of a cylinder chamber in which a plunger is slid, there is a problem that film formation by coating, smoothing, processing, machining or the like is needed.

As described above, in a case where the surface accuracy or durability of the cylinder chamber is poor, a hydraulic type tensioner in which a separate part of metallic cylinder was fit into a cylinder-to-be fit hole is known to improve the surface accuracy or durability of the cylinder chamber (Japanese Unexamined Application, First Publication 2000-346152). However, since the body of the tensioner is made of metal, the mass of the tensioner is large. In this case it is necessary for preventing the dislodgement of the cylinder to form an annular concave groove on an inner surface of the cylinder-to-be fit hole and mount a snap ring on the concave groove. As a result, steps of the formation of the concave groove and the mounting of the snap ring are required, which increases the production cost. Further, since this hydraulic type tensioner does not include means for preventing oil leakage through the gap between the cylinder-to-be fit hole and the cylinder, there is a problem that oil leakage is performed through the gap.

### SUMMARY OF THE INVENTION

It is, accordingly, a general object of the present invention to overcome the problems associated with the above-mentioned conventional hydraulic type tensioner.

A more specific object of the present invention is to provide a hydraulic type plastic tensioner in which the weight reduction of a tensioner body and thus the weight reduction of the tensioner are obtained.

Another object of the present invention is to provide a hydraulic type plastic tensioner in which the mounting of a cylinder and the assembling of the tensioner can be facilitated.

Another object of the present invention is to provide a hydraulic type plastic tensioner in which oil leakage through the gap between a cylinder to be fit hole (circular hole) formed in a tensioner body and a cylinder is prevented.

Another object of the present invention is to provide a hydraulic type plastic tensioner in which a dislodgement of the cylinder can be prevented.

Still another object of the present invention is to provide a hydraulic type plastic tensioner in which an increase in oil leakage through the gap between the slide contact surfaces of a plunger and a cylinder is prevented.

According to one aspect of the present invention, there is provided a hydraulic type plastic tensioner comprising: a body of said tensioner; a metallic cylinder fit into a circular hole formed in said body of the tensioner; a plunger inserted into said cylinder, the front end portion of said plunger being protruded from said body by a compression spring provided in said cylinder; a pressure oil chamber formed between the inside of said plunger and said cylinder; and a check valve mechanism that allows the flowing of oil into said pressure oil chamber but blocks the back flow of the oil; wherein said body of the tensioner is made of plastics.

According to the present invention, since the body of the tensioner is made of plastics, the weight reduction in the body of the tensioner can be obtained and thus the weight reduction in the tensioner can be realized. Further, a metallic cylinder fit into the circular hole formed in the plastic body of the tensioner allows the reinforcement of a sliding portion between the cylinder and the plunger.

Further, according to the present invention, the film formation, smoothing or machining for the cylinder chamber in which a plunger is slid, which processes were performed in a metallic body of the tensioner, are not required, and when a plastic cylinder is fit into the circular hole formed in the tensioner body, machining or the like of the wall surface of the hole becomes unnecessary, whereby the mounting of the cylinder and the assembling of the tensioner can be facilitated.

It is preferable that the check valve mechanism comprises a ball seat provided on a bottom portion of the circular hole, a check ball biased with a spring which can be abutted on a through-hole formed in the ball seat and a retainer, which supports the spring, and wherein the cylinder is a retainer-integrated type cylinder in which the cylinder body and the retainer are integrally formed, and the retainer of said cylinder is press-fit into the ball seat.

It is also preferable that the ball seat is fit onto a cylindrical protruded portion raised on the bottom portion of said circular hole, and the retainer is press-fit onto the ball seat whereby the cylinder is held in the circular hole.

According to the present invention, since the ball seat is separate from the cylinder, only the ball seat can be subjected to wearability processing. Thus, wear in the vicinity of the through-hole in the ball seat can be prevented and thus the life of the tensioner can be extended.

According to the present invention, the ball seat is preferably fit into a small-diameter circular hole formed on a lower portion of the bottom portion of said circular hole and said retainer is press-fit onto said ball seat whereby said cylinder is held in said circular hole.

Further, according to the present invention, since the cylinder is a retainer-integrated type cylinder in which the cylinder body and the retainer formed on the bottom plate provided on a bottom portion of the cylinder body were integrally formed and the retainer is press-fit into the ball seat, the oil leakage from the pressure oil chamber to the outer circumferential surface side of the cylinder can be prevented.

Furthermore, since the retainer-integrated type cylinder in which the retainer was press-fit onto the ball seat is fit into the circular hole, the number of curved points is increased in an oil leakage path to the outer circumferential portion of the cylinder and the oil leakage to the gap between the circular hole and the cylinder is suppressed, and thus the oil leakage through this gap can also be suppressed.

The plastic body of the tensioner preferably includes a backward displacement prevention mechanism for the plunger, comprising ratchet teeth carved on an outer circumferential surface of the plunger and a ratchet body that is engaged with the ratchet teeth by a spring bias.

According to the present invention, since the backward displacement mechanism is provided, when the plunger is going to move backward over the backlash range, the backing of the plunger is blocked by the engagement between the ratchet teeth and the pawls of the ratchet. Further, by utilizing the compression spring for protruding the plunger from the body of the tensioner the compression spring biases the bottom plate of the cylinder and the dislodgement of the cylinder can be prevented without a fastener for the cylinder such as a snap ring of another member. This effect is particularly efficiency when the tensioner is used in a high temperature atmosphere and the looseness between the cylinder and the circular hole is produced by the difference between their coefficients of the thermal expansion.

Further, according to the present invention, it is preferable an O-ring is provided between the bottom portion of the circular hole and the bottom plate of the cylinder. When the O-ring is provided between the bottom portion of the circular hole in the plastic body of the tensioner and the bottom plate of the cylinder the oil leakage through the gap between the circular hole and the cylinder can be further suppressed, and even if the tensioner was used at high temperature atmosphere and looseness was generated between the circular hole and the cylinder thereby to form a gap therebetween, the oil leakage through the gap can be prevented.

### BRIEF DESCRIPTION OF THE DRAWINGS

Preferred Embodiments of the present invention will now be described in detail with reference to the accompanying drawings, in which:

FIG. 1 is a cross-sectional view of a tensioner of a first Embodiment according to the present invention;

FIG. 2 is a cross-sectional view of a tensioner of a second Embodiment according to the present invention;

FIG. 3 is a cross-sectional view of a tensioner of a third Embodiment according to the present invention;

FIG. 4 is a cross-sectional view of a tensioner of a fourth Embodiment according to the present invention;

FIG. 5 is a cross-sectional view of a tensioner of a fifth Embodiment according to the present invention;

FIG. 6 is a perspective view of a cylinder according to the present invention;

FIG. 7 is a cross-sectional view of a tensioner of a sixth Embodiment according to the present invention; and

FIG. 8 is a cross-sectional view of a conventional tensioner.

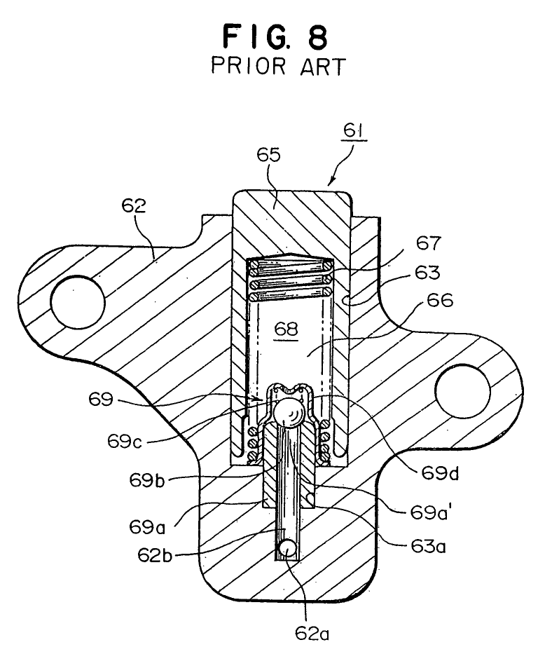

### DETAILED DESCRIPTION OF THE PREFERRED EMBODIMENTS

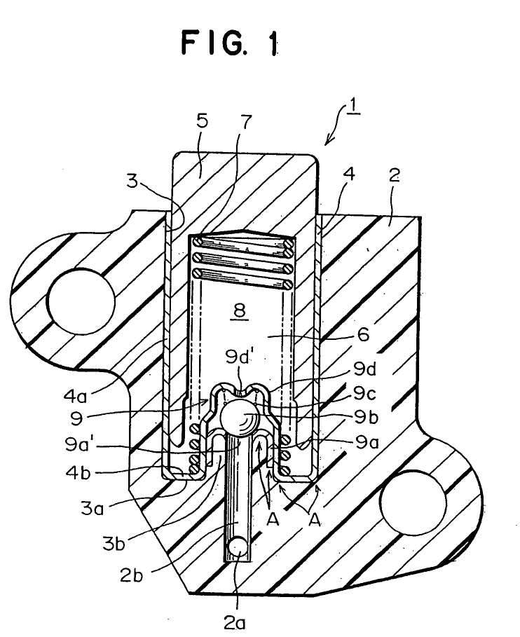

A first Embodiment according to the present invention will be described below with reference to FIG. 1. FIG. 1 shows a cross-sectional view of a hydraulic type plastic tensioner 1. The details of the tensioner 1 will be explained below. This tensioner 1 of the first Embodiment substantially comprises a steel cylinder 4 fit into a circular hole 3 formed in a plastic body 2 of the tensioner 1, a plunger 5 inserted into the cylinder 4 in such a manner that the top end portion of the plunger 5 is protruded from the body 2 of the tensioner 1 by a compression spring 7 provided in the cylinder 4, a pressure oil chamber 8 formed between the inside of the plunger 5 and the cylinder 4 and a check valve mechanism 9, which allows the flowing of oil into the pressure oil chamber 8, but blocks the back flow of the oil.

The circular hole 3 for fitting the cylinder into in the plastic body 2 of the tensioner 1. This circular hole 3 includes a cylindrical protrusion portion 3b raised at the center of the bottom portion 3a, and oil is supplied into the pressure oil chamber 8 with an external pump through an oil flow-in port 2a and an oil passage 2b formed in the protrusion portion 3b and body 2.

The cylinder 4 is a retainer-integrated type cylinder in which a cylinder body 4a, a ring-shaped bottom plate 4b, and a retainer 9d raised upward at the center of the bottom plate 4b were integrally formed, and the retainer 9d forms a part of the check valve mechanism 9, which will be described later.

The plunger 5 includes a hollow portion 6, whose lower end portion is opened inside thereof, and the pressure oil chamber 8 is formed of the plunger 5 and the cylinder 4 by inserting the plunger 5 into the cylinder 4. Further, the compression spring 7 for applying proper tension to a chain or belt or the like to protrude the top end of the plunger 5 is accommodated in this pressure oil chamber 8. The front-end portion of the compression spring 7 abuts on the interior top of the plunger 5 and the rear-end portion of the compression spring 7 abuts on the bottom plate 4b of the cylinder 4.

The check valve mechanism 9 is provided on the bottom portion of the pressure oil chamber 8, which mechanism 9 allows the flowing of oil into the pressure oil chamber 8 but blocks the back flow of the oil. The check valve mechanism 9 comprises a ball seat 9a having a through-hole 9a a check ball 9b, which can be abutted on the through-hole 9a′, a spring 9c, which biases the check ball 9b to the through-hole 9a′ side, and the retainer 9d supporting the spring 9c. The reference numeral 9d′ in FIG. 1 denotes a through-hole formed in the retainer 9d.

The fitting of the cylinder 4 into the circular hole 3 formed in the plastic body 2 is performed by fitting the ball seat 9a forming the check valve mechanism 9 onto the cylindrical protruded portion 3b raised at the center of bottom portion of the circular hole 3, and press-fitting the integrated retainer 9d into the center of the bottom plate 4b of the cylinder 4 to hold the cylinder 4 in the circular hole 3. In this case, the protruded portion 3b raised on the bottom portion 3a of the circular hole 3 in the plastic body 2 is reinforced by the fitting of the ball seat 9a onto the protruded portion 3b.

In the hydraulic type plastic tensioner 1 having the above-mentioned construction, the pressure oil chamber 8 is always filled with oil supplied through the oil flow-in port 2a and oil passage 2b formed in the body 2, and the check valve mechanism 9, with a pump or the like. When a traveling chain or belt or the like is loosened, the plunger 5 is protruded by the compression spring 7 so that the check valve mechanism 9 is opened to allow oil to flow into the pressure oil chamber 8.

Then, when the chain, belt or the like is tightened and the tensioner receives impact force, whereby the plunger 5 is backed in the cylinder 4, the check ball 9b is brought into collision contact with the through-hole 9a′ of the ball seat 9a by oil pressure to close the check valve mechanism 9. Thus, when the check valve mechanism 9 is closed and oil pressure is increased, oil in the pressure oil chamber 8 is passed through a small gap between an outer circumferential surface of the plunger 5 and an inner circumferential surface of the cylinder 4 to be leaked outside. At that time the impact energy is absorbed by a fluid resistance in the passing of oil through the gap so that cushion effect can be obtained.

The construction and effects of the hydraulic type plastic tensioner 1 of the first Embodiment have been explained above. However, in this hydraulic type plastic tensioner 1, the check ball in the check valve mechanism is often brought into collision-contact with the ball seat by the vibration of repeated loosening and tightening of a traveling chain, and then a portion of the ball seat, with which the check ball comes into collision, in the vicinity of the through hole is easy to wear. Nevertheless, since the ball seat 9a, which forms the check valve mechanism 9, is a separate body from the cylinder 4, wearability processing for only the ball seat 9a can be performed. Thus, by the wearability processing of the ball seat 9a, the wear of a portion of the ball seat 9a in the vicinity of the through-hole 9a′ can be prevented, and thus the reduction in the life of the tensioner can be prevented.

The cylinder 4 is a retainer-integrated type cylinder in which the cylinder body 4a and the retainer 9d formed on the bottom plate 4b provided on a bottom portion of the cylinder body 4a were integrally formed. Further, since the retainer 9d is press-fit into the ball seat 9a, the oil leakage into the gap between the circular hole formed in the plastic body and the cylinder can be prevented. Furthermore, since the retainer-integrated type cylinder 4 in which the retainer-integrated type cylinder 4 was press-fit onto the ball seat 9a is fit into the circular hole 3, the number of curved points (A in FIG. 1) is increased in an oil leakage path to the outer circumferential portion of the cylinder 4 and the oil leakage to the gap between the circular hole 3 and the cylinder 4 is suppressed, and thus the oil leakage through this gap can also be suppressed.

In a case where the hydraulic type plastic tensioner 1 is installed on an engine, drive or the like, the plunger 5 provided such that the top end portion of the plunger 5 is protruded from the tensioner body 2 is pushed by the chain, belt or the like to be pushed into the cylinder 4. Thus, the compression spring 7 always biases the bottom plate 4b of the cylinder 4. As a result, even if the use of the tensioner in a high-temperature atmosphere has generated looseness between the cylinder and the circular hole, the dislodgment of the cylinder can be prevented without providing an additional securing member for the cylinder. Accordingly, the production of the hydraulic type plastic tensioner can be facilitated and the reduction in production cost can be realized.

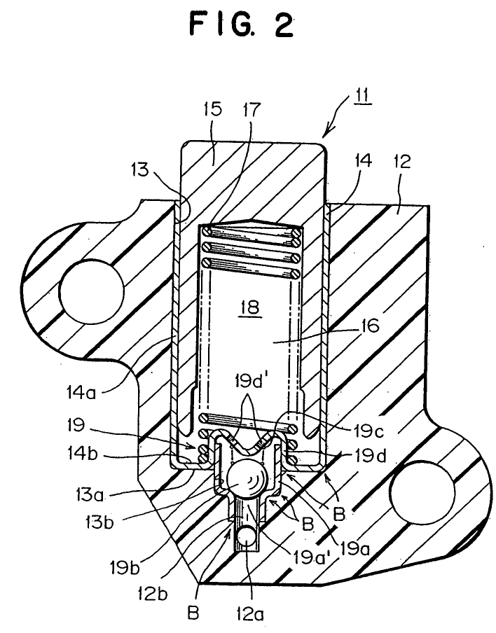

A second Embodiment according to the present invention will be described below with reference to FIG. 2. FIG. 2 shows a cross-sectional view of a hydraulic type plastic tensioner 11. This tensioner 11 of the second Embodiment comprises, as in said first Embodiment, a steel cylinder 14 fit into a circular hole 13 formed in a plastic body 12 of the tensioner 11, a plunger 15 inserted into the cylinder 14 in such a manner that the top end portion of the plunger 15 is protruded from the body 12 of the tensioner 11 by a compression spring 17 provided in the cylinder 14, a compression oil chamber 18 formed between the inside of the plunger 15 and the cylinder 14 and a check valve mechanism 19, which allows the flowing of oil into the pressure oil chamber 18, but blocks the back flow of the oil.

The circular hole 13 formed in the plastic body 12 of the tensioner 11 includes a small-diameter circular hole 13b having a diameter smaller than that of the circular hole 13 at the center of the bottom portion 13a, and oil is supplied into the small-diameter circular hole 13b with an external pump through an oil flow-in port 12a and an oil passage 12b formed in the body 12.

The cylinder 14 is a retainer-integrated type cylinder in which a cylinder body 14a, a ring-shaped bottom plate 14b, and a retainer 19d raised upward at the center of the bottom plate 14b were integrally formed, and the retainer 19d forms a part of the check valve mechanism 19, which will be described later.

The plunger 15 includes a hollow portion 16, whose lower end portion is opened, inside thereof, and the pressure oil chamber 18 is formed of the plunger 15 and the cylinder 14 by inserting the plunger 15 into the cylinder 14. Further, the compression spring 17 for applying proper tension to a chain or belt or the like to protrude the top end of the plunger 15 is accommodated in this pressure oil chamber 18. The front-end portion of the compression spring 17 abuts on the interior top of the plunger 15 and the rear-end portion of the compression spring 17 abuts on the bottom plate 14b of the cylinder 14.

The check valve mechanism 19 is provided on the bottom portion of the pressure oil chamber 18, which mechanism 19 allows the flowing of oil into the pressure oil chamber 18 but blocks the back flow of the oil. The check valve mechanism 19 comprises a ball seat 19a formed in stepped and circular shapes and having a through-hole 19a′ at the step, a check ball 19b, which can be abutted on the through-hole 19a′, a spring 19c, which biases the check ball 19b to the through-hole 19a′ side, and the retainer 19d supporting the spring 19c. The reference numeral 9d′ in FIG. 2 denotes a through-hole formed in the retainer 19d. Further, the ball seat 19a is subjected to wearability processing.

The fitting of the steel cylinder 14 into the circular hole 13 formed in the plastic body 12 is performed by fitting the ball seat 19a forming the check valve mechanism 19 onto the small-diameter circular hole 13b formed at the center of bottom portion of the circular hole 13, and press-fitting the integrated retainer 19d into the center of the bottom plate 14b of the cylinder 14 to hold the cylinder 14 in the circular hole 13.

In the hydraulic type plastic tensioner 11 having the above-mentioned construction, the ball seat 19a, which forms the check valve mechanism 19, is subjected to wearability processing. Thus, wear in the vicinity of the through-hole 19a in the ball seat 19a can be prevented and thus the life of the tensioner can be extended.

The cylinder 14 is a retainer-integrated type cylinder in which the cylinder body 14a and the retainer 19d formed on the bottom plate 14b provided on a bottom portion of the cylinder body 14a were integrally formed. Further, since the retainer 19d is press-fit into the ball seat 19a, the oil leakage into the gap between the circular hole 13 and the cylinder 14 can be prevented. Furthermore, since the retainer-integrated type cylinder 14 in which the retainer was press-fit onto the ball seat 19a is fit into the circular hole 13, the number of curved points (B in FIG. 2) is increased in an oil leakage path to the outer circumferential portion of the cylinder 14 and the oil leakage to the gap between the circular hole 13 and the cylinder 14 is suppressed, and thus the oil leakage through this gap can also be suppressed.

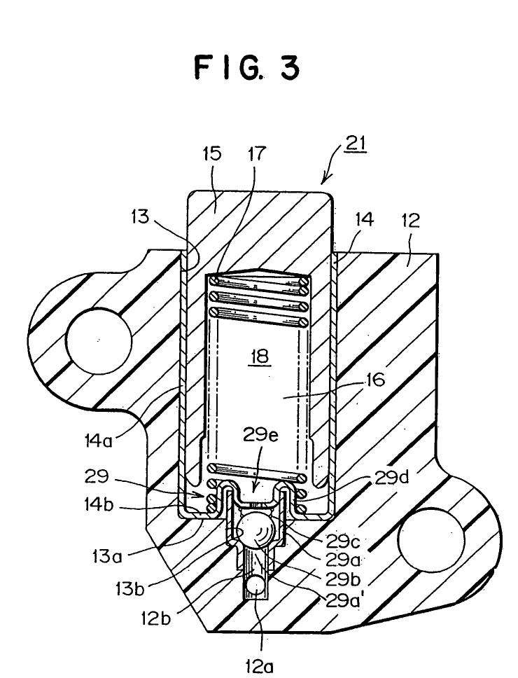

Third Embodiment of the present invention will be described below with reference to FIG. 3. FIG. 3 shows a cross-sectional view of a hydraulic type plastic tensioner 21. In this hydraulic type plastic tensioner 21, only the check valve mechanism is different from that of the hydraulic type plastic tensioner 11 of said second Embodiment. Thus, only the check valve mechanism in the hydraulic type plastic tensioner 21 will be explained and other concrete explanations are omitted. In this case, the same members as in said second Embodiment are denoted by the same reference numerals.

A cylinder 14 is a retainer-integrated type cylinder in which a cylinder body 14a, a ring-shaped bottom plate 14b, and a retainer 29d raised upward at the center of the bottom plate 14b were integrally formed, and the retainer 29d forms a part of a check valve mechanism 29.

The check valve mechanism 29 comprises a ball seat 29a formed in stepped and circular shapes and having a through-hole 29a′ at the step, a check ball 29b, which can be abutted on the through-hole 29a′, a spring 29c, which biases the check ball 29b to the through-hole 29a side, and the retainer 29d supporting the spring 29c. As shown in FIG. 3, the retainer 29d is formed in a convex-shaped portion 29e so that the upper central portion of the retainer 29d is protruded to the check ball 29b side, and the convex-shaped portion 29e is press-fit into the ball seat 29a.

The fitting of the steel cylinder 14 into the circular hole 13 formed in the plastic body 12 is performed by fitting the ball seat 29a forming the check valve mechanism 29 onto a small-diameter circular hole 13b formed at the center of bottom portion of a circular hole 13, and press-fitting the integrated retainer 29d into the center of the bottom plate 14b of the cylinder 14 to hold the cylinder 14 in the circular hole 13.

In the hydraulic type plastic tensioner 21 having the above-mentioned construction, the cylinder 14 is a retainer-integrated type cylinder in which the cylinder body 14a and the retainer 29d formed on the bottom plate 14b provided on a bottom portion of the cylinder body 14a were integrally formed. Further, since the retainer 29d is press-fit into the ball seat 29a, the oil leakage into the gap between the circular hole 13 and the cylinder 14 can be prevented.

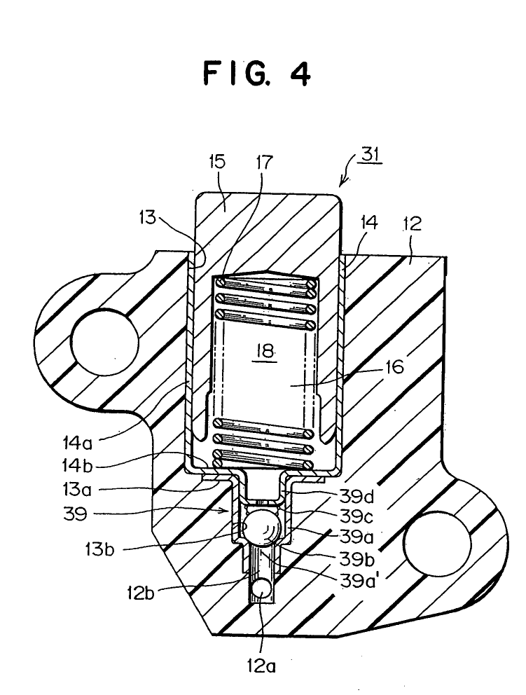

Fourth Embodiment of the present invention will be described below with reference to FIG. 4. FIG. 4 shows a cross-sectional view of a hydraulic type plastic tensioner 31. In this hydraulic type plastic tensioner 31, only the check valve mechanism is different from that of the hydraulic type plastic tensioner 11 of said second Embodiment. Thus, only the check valve mechanism in the hydraulic type plastic tensioner 31 will be explained and other concrete explanations are omitted. In this case, the same members as in said second Embodiment are denoted by the same reference numerals.

A cylinder 14 is a retainer-integrated type cylinder in which a cylinder body 14a, a ring-shaped bottom plate 14b, and a retainer 39d raised upward at the center of the bottom plate 14b were integrally formed, and the retainer 39d forms a part of a check valve mechanism 39.

The check valve mechanism 39 comprises a ball seat 39a formed in stepped and circular shapes and having a through-hole 39a′ at the step, a check ball 39b, which can be abutted on the through-hole 39a′, a spring 39c, which biases the check ball 39b to the through-hole 39a′ side, and the retainer 39d supporting the spring 39c. As shown in FIG. 4, the retainer 39d is formed in a convex-shape so that the upper central portion of the retainer 39d is protruded on a side lower than the bottom plate 14b of the cylinder 14, and this retainer 39d is press-fit into the ball seat 39a inside a small-diameter circular hole 13b.

The fitting of the steel cylinder 14 into a circular hole 13 formed in the plastic body 12 is performed by fitting the ball seat 39a forming the check valve mechanism 39 onto the small-diameter circular hole 13b formed at the center of bottom portion of the circular hole 13, and press-fitting the convex-shaped retainer 39d protruded on the lower side than the bottom plate 14b of the cylinder 14 to hold the cylinder 14 in the circular hole 13. In this hydraulic type plastic tensioner 31, the convex-shaped retainer 39d is press-fit into the ball seat 39a and the oil leakage to the gap between the circular hole 13 and the cylinder 14 can be prevented.

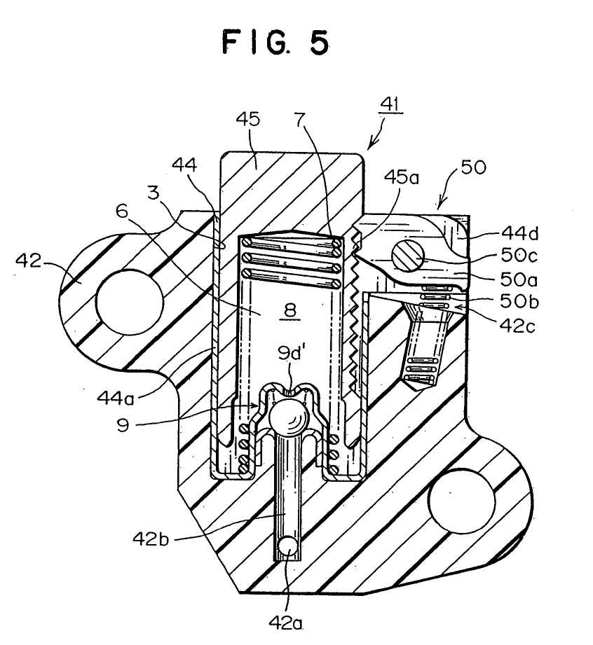

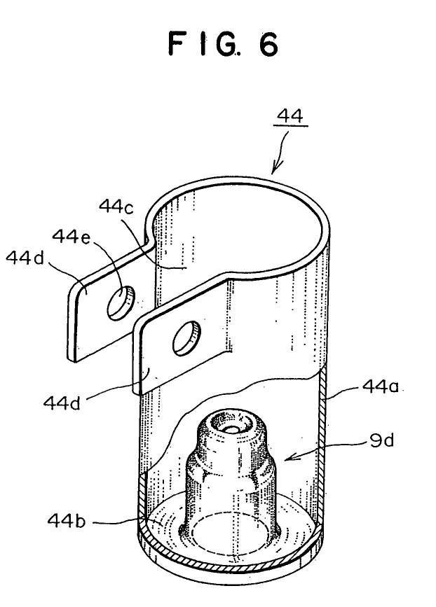

Fifth Embodiment of the present invention will be described below with reference to FIGS. 5 and 6. FIG. 5 shows a cross-sectional view of a hydraulic type plastic tensioner 41. This hydraulic type plastic tensioner 41 includes a backward displacement prevention mechanism for a plunger so that the plunger in the hydraulic type plastic tensioner 1 of first Embodiment is not further moved backward than required. Accordingly, the backward displacement prevention mechanism for a plunger will be principally explained, and other concrete explanations are omitted. In this case, the same members as in said first Embodiment are denoted as the same reference numerals.

The backward displacement prevention mechanism 50 for the plunger comprises ratchet teeth 45a carved around the outer circumferential surface of a plunger 45 and a ratchet pawl 50a. In a body 42 of the tensioner 41 is formed a cutout portion 42c, which communicates with a circular hole 43. To prevent the backward movement of the plunger 45 the ratchet pawl 50a, which engages with the ratchet teeth 45a carved around the circumferential surface of the plunger 45 is pivotably provided in the cutout portion 42c while biased by a ratchet spring 50b. In this case, backlash is provided between the ratchet teeth 45a and the pawl 50a of the ratchet 50.

As shown in FIG. 5 and FIG. 6, in a cylinder 44, a cylinder body 44a, a bottom plate 44b and a retainer 9d forming a check valve mechanism 9 and the like are integrally formed, and a cutout portion 44c is formed in such a manner that the ratchet pawl 50a is pivoted and can be engaged with the ratchet teeth 45a of the plunger 45. Further, a pair of protruded pieces 44d, 44d extending from an end of the cutout portion 44c to the outside. The ratchet pawl 50a is supported by a shaft 50c inserted through a shaft-hole 44e formed in the protruded piece 44d and a shaft-hole formed in the body 42.

The action of the hydraulic type plastic tensioner 41 is as follows. When a traveling chain, belt or the like is loosened, the plunger 45 is protruded by a compression spring 7 and the check valve mechanism 9 is opened to allow oil to flow into a pressure oil chamber 8. Then, when the chain, belt or the like is tightened, the plunger 45 is moved backward into the cylinder 44 under impact force on the tensioner and the check valve mechanism 9 is closed, whereby oil in the pressure oil chamber 8 is passed through a small gap between an outer circumferential surface of the plunger 45 and an inner circumferential surface of the cylinder 44 to leak outside. The impact energy is absorbed by the fluid resistance at the time and the cushion effect can be obtained. In this case, when the plunger 45 is going to be moved backward to exceed the backlash range, since the backward displacement prevention mechanism 50 is provided, the backward movement of the plunger 45 can be blocked by engagement between the ratchet teeth 45a and the ratchet pawl 50a.

When a chain, belt or the like is extended by long operation so that the plunger 45 exceeds the backlash range and is protruded from the body 42, the check valve mechanism 9 is opened to supply oil into the pressure oil chamber 8 through an oil flow-in port 42a and oil passage 42b, and at the same time the engagement between the ratchet teeth 45a in the plunger 45 and the ratchet pawl 50a is shifted by one tooth and the plunger 45 is always moved outside the body 42 according to the extension of the chain or belt.

In the hydraulic type plastic tensioner 41 having the above-mentioned construction, the shaft 50c, which supports the ratchet body 50a, is supported by the shaft hole 44e formed in the protruded piece 44d in the steel cylinder 44. Thus, breakage of the shaft-supporting portion in the plastic body 42 is prevented. Also, since the protruded piece 44d formed in the cylinder 44 is fixed to the body 42 by the shaft 50c, the dislodgment of the cylinder 44 from a circular hole 43 formed in the body 42 can reliably be prevented.

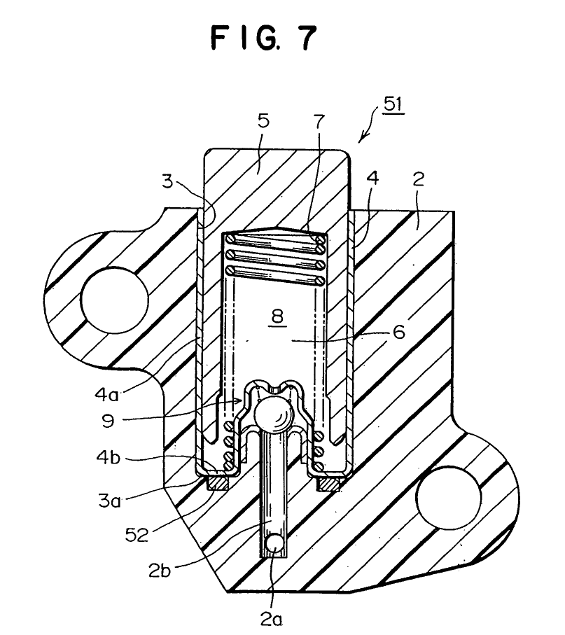

Sixth Embodiment of the present invention will be described below with reference to FIG. 7. FIG. 7 shows a cross-sectional view of a hydraulic type plastic tensioner 51. This hydraulic type plastic tensioner 51 has such a construction that the hydraulic type plastic tensioner 1 of first Embodiment incorporates an O-ring to further ensure the prevention of oil leakage. The same members as in the first Embodiment are only denoted as the same reference numerals, and concrete explanations thereof are omitted.

According to the hydraulic type plastic tensioner 51, by providing an O-ring 52 on a bottom portion 3a of a circular hole 3 formed in a plastic body 2, the prevention of oil leakage through the gap between the bottom portion 3a and the bottom plate 4b of the cylinder 4 can be further improved.

Although the first to sixth Embodiments of the present invention have been described above, the cylinder is not limited to the steel cylinder but a cylinder made of other iron-based metal, aluminum-based alloy or the like may be used. As a concrete example of the hydraulic type plastic tensioner including a backward displacement prevention mechanism for the plunger, the fifth Embodiment of the invention in which the backward displacement prevention mechanism for the plunger was provided on the hydraulic type plastic tensioner in the first Embodiment was described. However, this backward displacement prevention mechanism for the plunger may be provided in the hydraulic type plastic tensioners according to said second to fourth Embodiments and sixth Embodiment. Further, as a concrete example of the hydraulic type plastic tensioner including an O-ring to prevent further oil leakage, the sixth Embodiment of the present invention in which the O-ring was provided on the hydraulic type plastic tensioner in the first Embodiment was described. However, this O-ring may be provided in the hydraulic type plastic tensioners according to said second to fifth Embodiments.

Obviously, various minor changes and modifications of the present invention are possible in the light of the above teaching. It is therefore to be understood that within the scope of the appended claims, the present invention may be practiced otherwise than as specifically described.

What is claimed is:

1. A hydraulic type plastic tensioner comprising:
a body of said tensioner:
a metallic cylinder fit into a circular hole formed in said body of the tensioner;
a plunger inserted into said cylinder, the front end portion of said plunger being protruded from said body by a compression spring provided in said cylinder;
a pressure oil chamber formed between the inside of said plunger and said cylinder; and
a check valve mechanism that allows the flowing of oil into said pressure oil chamber but blocks the back flow of the oil;
wherein said body of the tensioner is made of plastics.

2. The hydraulic type plastic tensioner according to claim 1, wherein said check valve mechanism comprises a ball seat provided on a bottom portion of said circular hole, a check ball biased with a spring which can be abutted on a through-hole formed in said ball seat and a retainer, which supports said spring, and wherein said cylinder is a retainer-integrated type cylinder in which the cylinder body and said retainer are integrally formed, and said retainer of said cylinder is press-fit into said ball seat.

3. The hydraulic type plastic tensioner according to claim 2, wherein said ball seat is fit onto a cylindrical protruded portion raised on the bottom portion of said circular hole, and said retainer is press-fit onto said ball seat whereby said cylinder is held in the circular hole.

4. The hydraulic type plastic tensioner according to claim 2, wherein said ball seat is fit into a small-diameter circular hole formed on a lower portion of the bottom portion of said circular hole and said retainer is press-fit onto said ball seat whereby said cylinder is held in said circular hole.

5. The hydraulic type plastic tensioner according to any one of claims 1 to 4, wherein said plastic body of the tensioner includes a backward displacement prevention mechanism for the plunger, comprising ratchet teeth carved on an outer circumferential surface of the plunger and a ratchet body that is engaged with said ratchet teeth by a spring bias.

6. The hydraulic type plastic tensioner according to any one of claims 1 to 5, wherein an O-ring is provided between the bottom portion of said circular hole and the bottom plate of said cylinder.
